(19) United States
(12) Patent Application Publication
(10) Pub. No.: US 2008/0291665 A1
(43) Pub. Date: Nov. 27, 2008

(54) SOLAR BIRDFEEDER WITH WIND CHIME

(75) Inventors: HENDRA WIJAYA, ARLINGTON, TX (US); GOU JUN, XINHAU TOWN (CN)

Correspondence Address: HOWISON & ARNOTT, L.L.P, P.O. BOX 741715, DALLAS, TX, 75374-1715, US

(73) Assignee: FOREVER GIFTS, INC., ARLINGTON, TX (US)

(21) Appl. No.: 11/752,498

(22) Filed: May 23, 2007

(51) Int. Cl. F21L 4/08

(52) U.S. Cl. 362/183

(57) ABSTRACT

An apparatus includes a bird feeder having a base and a cover. A plurality of wind chime tubes are hung from the base of the bird feeder as is a transparent striker. The transparent striker is hung in such a manner to hit the plurality of wind chimes responsive to a blowing wind. A light is suspended within the transparent striker that is powered by a rechargeable battery. A solar power conversion system provides electricity to the rechargeable battery responsive to sunlight.

### TECHNICAL FIELD

The present invention relates to birdfeeders and windchimes, and more particularly, to a combination birdfeeder and windchime including solar powered lighting.

### CROSS-REFERENCE TO RELATED APPLICATIONS

None.

### BACKGROUND

The use of birdfeeders and wind chimes are widely known for use as decorative items for an individual's patio or garden. The wind chimes provide a pleasing sound to individual's relaxing within their patio or garden, and the birdfeeder attracts local birds to the area for viewing and enjoyment. To date, these items have been separately constructed requiring an individual to purchase each item if they wish to enjoy the benefits of the birdfeeder and the wind chime. Additionally, outdoor lighting products must be additionally purchased for patio or garden enjoyment to assist in enjoyment of the patio or garden in the night-time hours. Thus, some device for combining the advantages for all of these pleasing patio or garden accessories would be greatly desirable.

### SUMMARY

The present invention, as disclosed and described herein, in one aspect thereof, comprises an apparatus including a birdfeeder having a base and a cover. A plurality of wind chime tubes are hung from the base of the birdfeeder. Additionally, a transparent striker is suspended from the base of the bird feeder in such a manner to hit the plurality of wind chime tubes responsive to a blowing wind. A light suspended within the transparent striker is powered by a rechargeable battery. A solar powered conversion system provides electricity to the rechargeable battery responsive to sunlight.

### BRIEF DESCRIPTION OF THE DRAWINGS

For a more complete understanding of the present invention and the advantages thereof, reference is now made to the following description taken in conjunction with the accompanying Drawings in which:

FIG. 1 is an illustration of a first embodiment of a combined birdfeeder and wind chime including solar powered lighting;

FIG. 2 is an alternative embodiment of a combination birdfeeder and wind chime including solar powered lighting; and

FIG. 3 is a functional block diagram illustrating the electrical circuitry associated with the combination birdfeeder and wind chime including solar powered lighting.

### DETAILED DESCRIPTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

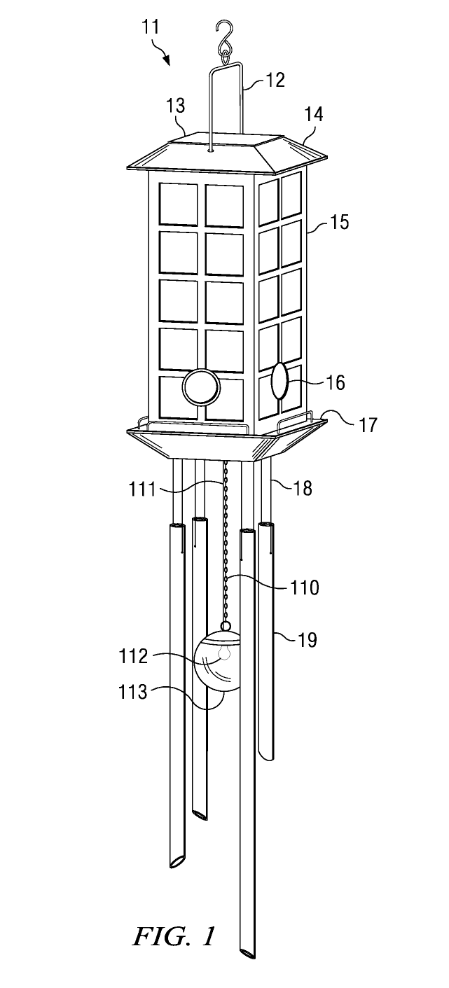

Referring now to FIG. 1, there is illustrated a first embodiment of the combination birdfeeder and wind chime including a solar powered lighting functionality. The birdfeeder 11 consists of a hanging mechanism 12 which may comprise a hook, rope or loop for suspending the birdfeeder and wind chimes from the eave of a roof or a stand within a patio or garden. A food container 15 includes a container for holding the bird seed that is provided to feeding holes 16 of the bird feeder. A bird may stand upon a base or perch 17 upon which the food container 15 rests. While standing upon the base or perch 17 the birds are able to eat birdseed contained within the food container 15 through the feeding holes 16. A top cover 14 covers the food container 15 and may be removed to enable the addition of bird seed within the food container 15.

A solar power conversion device 13, for example a solar cell, is located on top of the top cover 14 in a position to allow easy access to light provided by the sun. The solar power conversion device 13 may be located at any position on the top cover 14 or alternatively, in any position upon the combination birdfeeder and wind chimes. While the present disclosure envisions the solar power conversion device 13 being located on the bird feeder 11, in alternative embodiments, the solar power conversion device 13 may be located separately from the bird feeder 11 such that the solar power conversion device 13 could be placed in a sunny area while the bird feeder was placed within the shade. The electrical circuitry and rechargeable battery, which will be discussed more fully herein below, would then be interconnected with the solar power conversion device 13 via a wire.

Hanging from the base 17 of the bird feeder 11 is the wind chime consisting of a number of wind chime tubes 19 and a striker 113. The wind chime tubes 19 are suspended from the base 17 via string 18. Chains or other items may be used for suspending the wind chime tubes 19 from the base 17. The striker 113 is suspended from the base 17 via a chain 110. In addition, a chain, rope, twine, plastic, tubing or other item may be used to suspend the striker 113. As is well known, the wind will cause the striker 113 to strike the chime tubes 19 causing the chiming sound to be provided from the wind chime.

The striker 113 comprises a transparent globe or other transparent, geometrically shaped element enabling a light 112 to be placed therein. The light 112 in a preferred embodiment comprises an LED but other forms of light emitting components may be utilized. The light is connected to a rechargeable battery via a connecting wire 111. Referring now also to FIG. 3, there is more fully illustrated a block diagram of the electrical components of the combination birdfeeder and wind chime including a lighting functionality. The electrical circuitry may be located at any position within the birdfeeder 11. For example, it could be placed on the bottom side of the cover 14 or on the top or bottom of the base 17. The electrical circuitry consists of the solar power conversion device 302 consisting of some type of solar cell and associated circuitry necessary to convert solar energy into electrical power. The electrical power is provided to charging circuitry 303 that charges a rechargeable battery 304 using the electrical power from the power conversion device 302. The rechargeable battery 304 is used to power a light 306 or other type of electrical device.

In the preferred embodiment the light 306 is located within the transparent striker 113. In one embodiment, the light or other electrical device 306 is turned on and off by a photosensor 308. Thus, when it became dark, the light 306 will automatically turn on responsive to a signal generated by the photosensor 308. In alternative embodiments, rather than utilizing a photosensor 308, a manual on/off switch could be used such that the globe may be turned on and off as desired. Additionally, the manual on/off switch could be used in conjunction with the photosensor 308 to enable the light to be turned off at night time when it was not desired. The striker 113 is suspended in such a manner to enable the light 112 to illuminate the chime tubes 19.

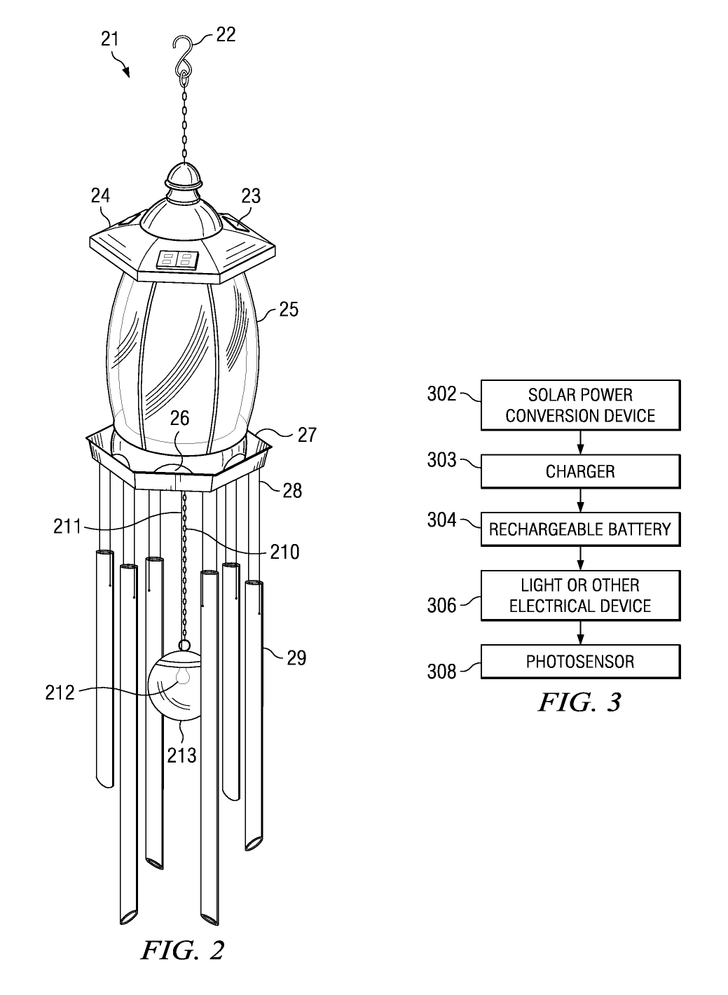

Referring now to FIG. 2, there is illustrated an alternative embodiment of the combination birdfeeder and wind chime. In this configuration, the birdfeeder 21 includes a food container 25 including a lantern shape rather than the square shape illustrated earlier. The hanging mechanism 22 comprises a single chain and hook connected to the cover 24. Multiple solar power conversion devices 23 are placed on the top cover 24. Birdfeeder holes 26 at the base of the food container 25 enable birds perched upon the base or perch 27 to take food from the food container 25. As before, chime tubes 29 are suspended from the base 27 and a transparent striker 213 having a light 212 therein is suspended by a chain 210 and powered by a wire 211 connecting to the rechargeable battery.

It will be appreciated by those skilled in the art having the benefit of this disclosure that this invention provides a combined birdfeeder and wind chime including a solar powered light. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. At apparatus, comprising:
a birdfeeder having a base and a cover;
a plurality of wind chime tubes hanging from the base of the birdfeeder;
a transparent striker suspended from the base of the birdfeeder to hit the plurality of wind chime tubes responsive to a blowing wind;
a light suspended within the transparent striker;
a rechargeable battery for providing power to the light; and
a solar power conversion system for providing electricity to the rechargeable battery responsive to sunlight.

2. The apparatus of claim 1, wherein the solar power conversion system includes a solar cell on the cover of the birdfeeder.

3. The apparatus of claim 1, wherein the light comprises an LED.

4. The apparatus of claim 1, further including a photo sensor for automatically turning on and off the light responsive to light conditions.

5. The apparatus of claim 1, further including a switch for manually turning on and off the light.

6. The apparatus of claim 1, wherein the transparent striker is suspended to enable the light inside the striker to illuminate the plurality of wind chime tubes.

7. The apparatus of claim 1, wherein the solar powered conversion device is located remotely from the birdfeeder and provides the electricity to the rechargeable battery via a connecting wire.

8. At apparatus, comprising:
a birdfeeder having a base and a cover;
a plurality of wind chime tubes hanging from the base of the birdfeeder;
a transparent striker suspended from the base of the birdfeeder to hit the plurality of wind chime tubes responsive to a blowing wind;
an LED suspended within the transparent striker;
a rechargeable battery for providing power to the LED;
a solar power conversion system for providing electricity to the rechargeable battery responsive to sunlight;
a photo sensor for automatically turning on and off the light responsive to light conditions; and
wherein the transparent striker is suspended to enable the LED inside the striker to illuminate the plurality of wind chime tubes.

9. The apparatus of claim 8, wherein the solar power conversion system includes a solar cell on the cover of the birdfeeder.

10. The apparatus of claim 8, further including a switch for manually turning on and off the light.

11. The apparatus of claim 8, wherein the solar powered conversion device is located remotely from the birdfeeder and provides the electricity to the rechargeable battery via a connecting wire.

12. At apparatus, comprising:
a birdfeeder having a base and a cover;
a plurality of wind chime tubes hanging from the base of the birdfeeder;
a transparent striker suspended from the base of the birdfeeder to hit the plurality of wind chime tubes responsive to a blowing wind;
a light suspended within the transparent striker;
a rechargeable battery for providing power to the light;
at least one solar cell for converting light into electricity located on the birdfeeder;
a charging circuit powered by the electricity provided by the at least one solar cell for recharging the rechargeable battery;
wherein the transparent striker is suspended to enable the light inside the striker to illuminate the plurality of wind chime tubes.

13. The apparatus of claim 12, wherein the light comprises an LED.

14. The apparatus of claim 12, further including a photo sensor for automatically turning on and off the light responsive to light conditions.

15. The apparatus of claim 12, further including a switch for manually turning on and off the light.
